(19) United States
(12) Patent Application Publication
(10) Pub. No.: US 2016/0205135 A1
(43) Pub. Date: Jul. 14, 2016

(54) METHOD AND SYSTEM TO ACTIVELY DEFEND NETWORK INFRASTRUCTURE

(71) Applicant: Nguyen Nguyen, Vienna, VA (US)

(72) Inventor: Nguyen Nguyen, Vienna, VA (US)

(21) Appl. No.: 14/597,210

(22) Filed: Jan. 14, 2015

(51) Int. Cl. H04L 29/06

(52) U.S. Cl. CPC H04L 63/1466; H04L 63/1416; H04L 63/20; H04L 63/101; H04L 63/0227; H04L 63/08

(57) ABSTRACT

Disclosed is an invention related to a system and device for actively defending a network infrastructure by implementing certain features that are attributed with lower performance cost and network complexity. The features implemented for protecting the network infrastructure comprises of: protecting the network from hostile scanning, providing a faster authenticated and limited access response to a network traffic request for sage guarding dedicated connections, intervening a TCP connection that is established between one or more clients and servers for terminating unwanted connections, and cleaning up SYN flood attacks to terminate one or more outstanding TCP connection.

### FIELD OF THE INVENTION

The present invention relates to a system and method for actively defending network infrastructure and more particularly to actively defend or protect network infrastructure by implementing certain features in the network that are attributed with reduced performance cost and network complexity.

### BACKGROUND OF THE INVENTION

Network security is a constant concern of almost every company that has a computer network. As the employees are allowed to telecommute or bring their own devices to the corporate network, the network infrastructure can be easily exposed to un-sanitized devices and computers. These devices and computers may perform scanning of the network to discover critical assets, potentially attempt to access servers, like database servers and file servers, and may attempt to perform denial-of-service attacks on the servers and network as well.

There has been prior work to perform network intrusion detection to help identify such behaviors. The network intrusion detection systems are often complicated to operate and most likely to report a lot of false alarms and will require network and system administrators manually filter out alarms. Network intrusion detection system typical reports incidents rather than preventing them from happening.

There are also mechanisms to restrict accesses to critical assets. They are typically implemented on the servers directly which consumes computing resources from the main service offered by these servers. Or, they are implemented at the gateway or firewalls as access control list (ACL) at the network firewalls, but the gateway is only able to restrict traffic that goes either in or out of the network. Additionally, gateways add additional latency to the traffic and reduce performance. The gateway approach is not very scalable as there is only one single place that performs the filtering. Additional firewalls can be added in series, but this complicates network topology, cost and performance degrading even further.

Therefore, there is a need to protect against network scanning, prevent unauthorized access, a mechanism to terminate intruding connections, and a mechanism to clean up the server during and after an attack without incurring heavy performance cost or making the network complex.

### SUMMARY OF THE INVENTION

The present invention is related to a system and device used to actively defend a network infrastructure by implementing features that are attributed with reduced performance cost and network complexity. The method implements one or more features to protect the network infrastructure: from hostile scanning, providing an easy to deploy and scalable access control filtering, intervening a Transmission Control Protocol (TCP) connection that is established between one or more clients and one or more servers within the network infrastructure, and a mechanism to clean up synchronize packet (SYN) flood or half-opened connection attacks by terminating one or more outstanding TCP connection.

Other objects and advantages of the embodiments herein will become readily apparent from the following detailed description taken in conjunction with the accompanying drawings.

### BRIEF DESCRIPTION OF THE DRAWING(S)

FIGS. 1a and 1b, according to an embodiment of the present invention, illustrate a network infrastructure integrated with an active network defending (AND) system or device for protecting the network infrastructure.

FIG. 2, according to an embodiment of the present invention, illustrates a flow-chart 200 that explains the process of protecting the network infrastructure by making the hostile scanning ineffective.

FIGS. 3a and 3b, according to an embodiment of the present invention, illustrate a block diagram of the network infrastructure integrated with an active network defending (AND) system or device.

FIGS. 4a and 4b, according to an embodiment of the present invention, illustrate a fictitious network provisioning feature implemented in the AND device.

FIG. 5, according to an embodiment of the present invention, illustrates the capability of the AND system or device to provide limited access or authorized access to the network resource.

FIG. 6, according to an embodiment of the present invention, illustrates the procedure followed for setting up a TCP connection and monitoring the TCP connection using a TCP watcher device.

FIG. 7, according to an embodiment of the present invention, illustrates the capability of the AND system or device to facilitate TCP connection clean up after a SYN flood attack on a server.

FIG. 8, according to an embodiment of the present invention, illustrates the capability of the AND system or device to terminate one or more unwanted connections to protect the network infrastructure.

FIG. 9, according to an embodiment of the present invention, illustrates the system overview of the components required to implement the features for protecting the network infrastructure.

### FIGURES—REFERENCE NUMERALS

100—Network infrastructure
101—External unfriendly or hostile host
102—External servers
103—External clients
104—Internet connection
105—Firewall provided for the network infrastructure
106—Router provided for the network infrastructure
107—A wireless client in the network infrastructure
108—A hostile wireless host
109—A wireless access point
110—A hostile host
111—A server host
112—A client host
113—An active network defender system or device

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

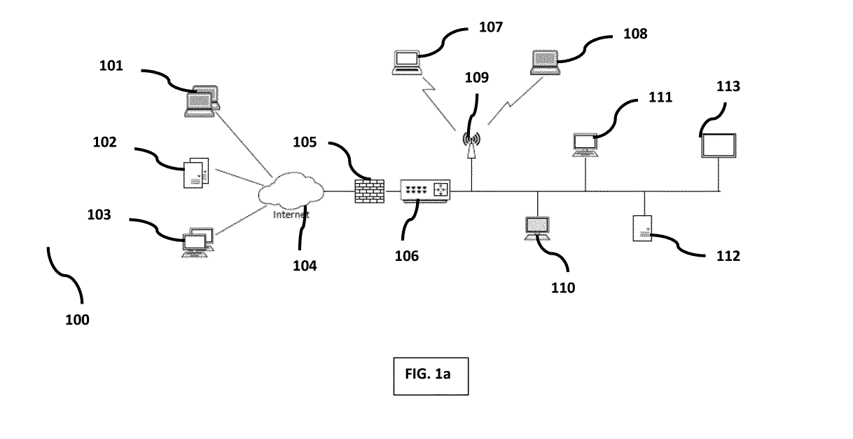

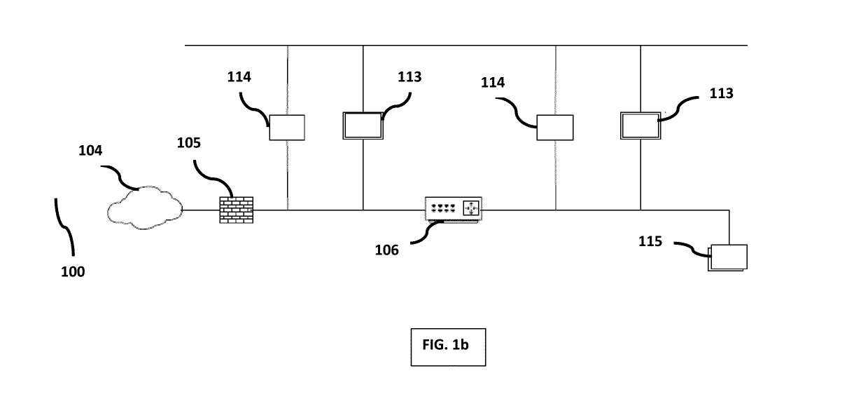

Referring to FIGs. 1a and 1b, illustrates the network infrastructure 100 integrated with an active network defending (AND) system or device 113 to protect the network infrastructure 100. In an embodiment, the network infrastructure 100 comprises of various assets within the network. The assets within the network includes but not limited to: a server host 101, a client host 110, an hostile wireless host 107, a firewall 104 integrated in the network infrastructure, a router 105 provided for the infrastructure, a wireless access point 109, and an active network defender system or device 113. In an embodiment, the AND system or device 113 implements one or more features to protect the network infrastructure 100. As depicted in FIG. 1b, the AND system or device 113 is used in conjunction with the intrusion detection system 114 to protect the network infrastructure 100.

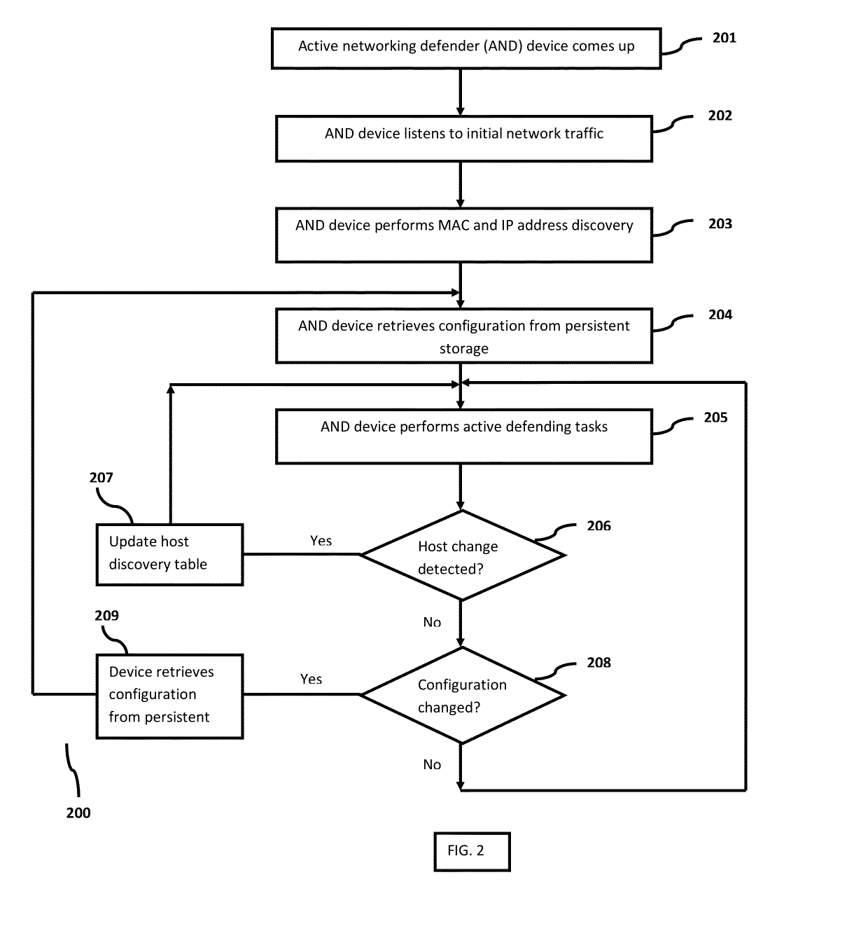

Referring to FIG. 2, illustrates a flow-chart 200 that explains the process of defending the network infrastructure by making the network scanning ineffective for the requests received from hostile hosts. Initially, at step 201, an AND system or device is activated or initialized within the network infrastructure. At step 202, as the AND system or device is initialized, the AND system or device constantly listens to the networking traffic within the network infrastructure 100. At step 203, the AND system or device listens to the networking traffic and identifies the MAC (Media Access Control) and IP (Internet Protocol) address of the network assets within the network infrastructure 100. At step 204, the AND system or device retrieves configuration details for the network assets identified within the network infrastructure 100 from persistent storage. Based on the retrieved configuration details, at step 205, the AND system or device activates one or more implemented features to protect the network infrastructure 100. In an embodiment, the AND system or device implements the following features to protect the network infrastructure 100:
Making hostile scanning ineffective.
Providing a scalable access control list (ACL) filtering.
Intervening a TCP connection that is established between one or more clients and one or more servers within the network infrastructure 100 to protect resources on the server.
Cleaning up SYN flood attacks by terminating at least one outstanding TCP connection.

In an embodiment, hostile scanning of the network is made ineffective by reporting many fictitious assets (associated with the network infrastructure) to an attacker that has no value to the attacker, and the process of making the hostile scanning of the network ineffective is termed as fictitious network provisioning. The fictitious network provisioning feature reports some of the opened ports on specified hosts as unavailable and reports nonexistent assets as available, which makes it difficult for an attacker to launch an attack to a valuable asset. In an embodiment, the fictitious network provisioning feature can be carried out by one or more AND network devices, connected in the network. The AND devices are coordinated through their management interfaces. Further, the network device listens to the traffic on the network and responds or rejects the traffic designated to their associated fictitious nodes on behalf of the fictitious nodes with the MAC (Media Access Control) and IP (Internet Protocol) addresses within the response time of the network device.

In an embodiment, the AND system or device 305 provides access filtering by via a scalable access control service. The Access control list (ACL) is a common way to limit access to network assets for certain groups. The ACL may be either blacklisted where elements in the list are rejected, or white listed where elements in the list are accepted, and other elements are rejected. At layer 3 (network layer) and layer 4 (transport layer), the access control list is usually implemented at a firewall (or gateway), where traffic is allowed or not allowed to flow through the firewall. This introduces extra network latency as the traffic passes through the firewalls, and it will also demand a more powerful and expensive firewall to reduce the processing impact on user traffic. There is also a limit on the number of entries that can be implemented on a firewall.

In an embodiment, the ACL feature is performed by using the filtering devices attached to the same network, as opposed to passing through a central filtering firewall. There is a clear advantage of this approach as the ACL device only needs to listen and process traffic as opposed to having to forward all packets through the central firewall. So, there is less demand on computing power of the device. When there is a need for adding more ACL entries than a single device can handle, the ACL can be distributed across multiple devices. In an embodiment, the ACL entries stored on the filtering device can be authorized independent of a gateway connection within the network. The filtering device is dedicated to process IP packets, so that the device can respond to network traffic request almost immediately, as compared to the workstation and servers that take longer time to respond as the workstation and servers rely on software layers in the operating systems and application software to perform the task. This allows the filtering device to intercept and respond to traffic as if the filtering device is an actual host. In an embodiment, the filtering device is the aliases of actual devices that are designated to keep certain traffic out from one or more network assets. When a disallowed traffic is destined to a host, the filtering device intercepts the request, and responds on behalf of the destination host. The response mimics the services unavailable in the host.

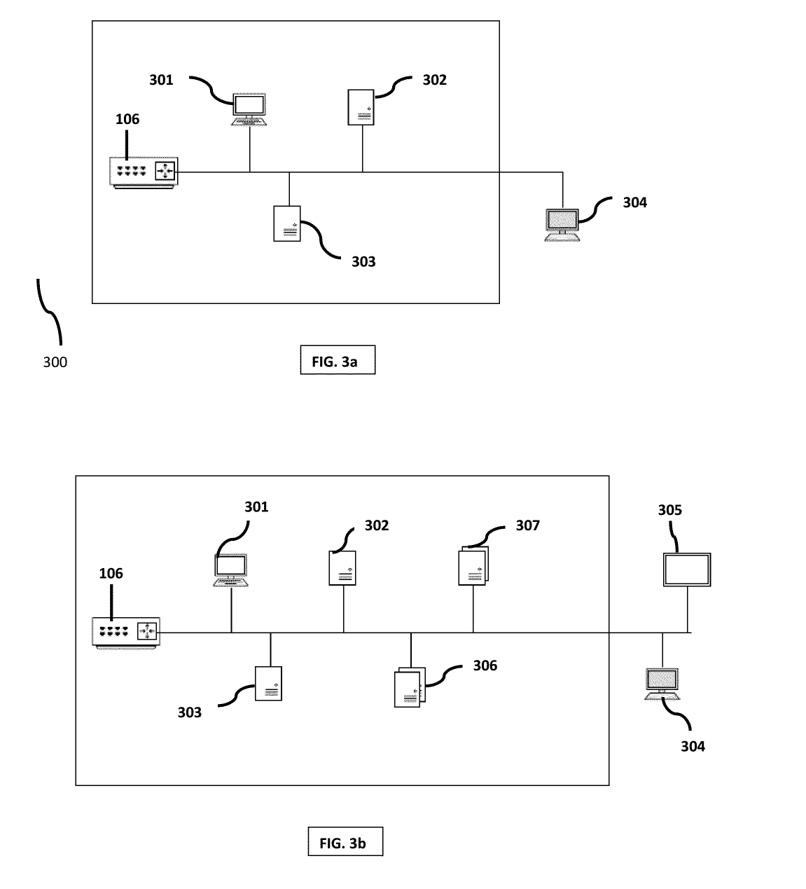

Referring to FIGS. 3a and 3b, illustrates a block diagram 300 of the network infrastructure 100 integrated with an AND system or device 305. In an embodiment, the AND system or device 305 listens to the network traffic and determines that one or more hosts 301, 302, or 303 TCP ports are opened within the network. As depicted in the FIG. 3a, the AND system or device 305 works in parallel with an unauthorized network scanner 304 to defend against unauthorized scanning of the entire network. Further, as depicted in the FIG. 3b, as the AND system or device listens to the networking traffic, the system or device 305 may determine that the traffic is not intended for certain specific hosts within the network infrastructure. Based on a scanned report, the system or device 305 combines the scanned report with the configuration details of the connected hosts in the network to intentionally report the presence of fictitious hosts 306, 307. In an embodiment, one or more real hosts/assets within the network infrastructure can be used as a destination for a fictitious host mapping. A fictitious host with assigned MAC address can be mapped to a real host or asset. In an embodiment, the AND system or device 305 maintains a fictitious network provisioning table for mapping fictitious hosts IP to specific real hosts. In an embodiment, the functionality of converting and mapping the real host IP addresses and ports to fictitious IP addresses and ports is emulated by the AND device. Further, the MAC address of the fictitious host is automatically assigned either by the operator or by the AND device using constraints from an operator and MAC information of the network that the AND device listens to. The AND does the fictitious host mapping functionality by receiving packets destined to a fictitious host and replacing destination IP and MAC addresses in the received packets with those of the real host that the fictitious host is mapped to. It also replaces the source IP address and MAC of the received packets with those of the fictitious host. Then it forwards the modified packet to the mapped host. For the response packets, the AND device performs the reserve MAC and IP replacement so that responses can get to original requesters.

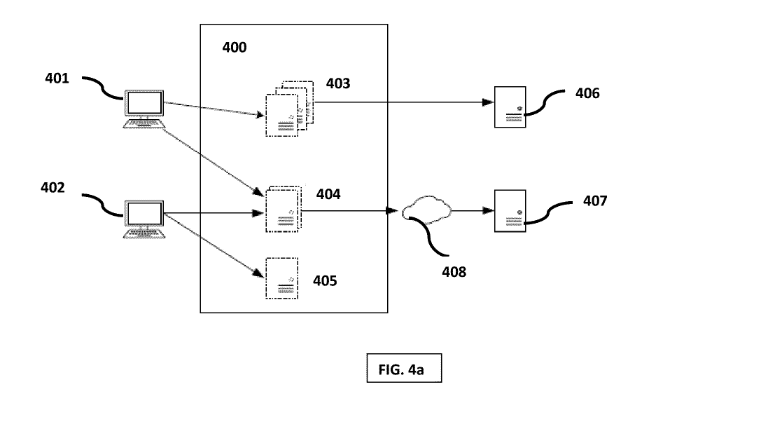

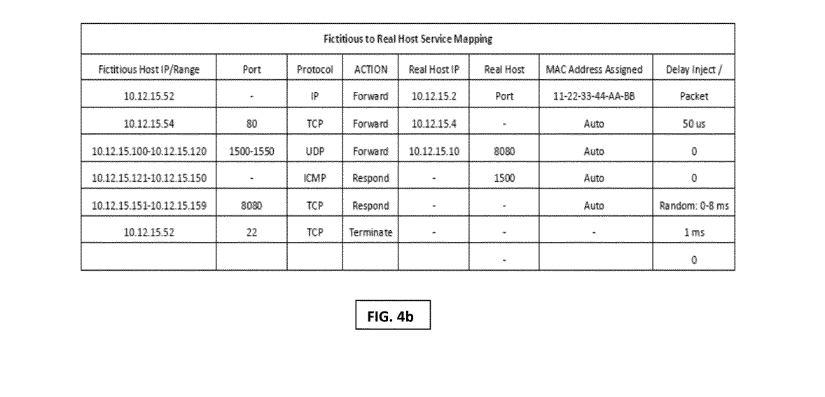

Referring to FIGS. 4a and 4b, illustrate a fictitious network provisioning feature implemented in the AND device 400. The AND system or device listens to the network traffic to keep a list of already in-use network and MAC addresses in the network infrastructure. This information will be used for not accepting fictitious hosts that are real and in use.

In FIG. 4a, the client host 401 tries to access fictitious hosts that are mapped to Internal Host 406 and External Host 407 respectively. Client 402 tries to access other fictitious hosts that are mapped to External Host 407 and internally built-in functions 405. The Fictitious Table in FIG. 4b determines the mapping.

Thus, when the Client Hosts 401 and 402 try to perform a network scanning of the infrastructure, they are unlikely to get the accurate assets attached to the network. This makes unauthorized network scanning ineffective as they may launch attacks to an in valid or low value assets rather than the critical assets.

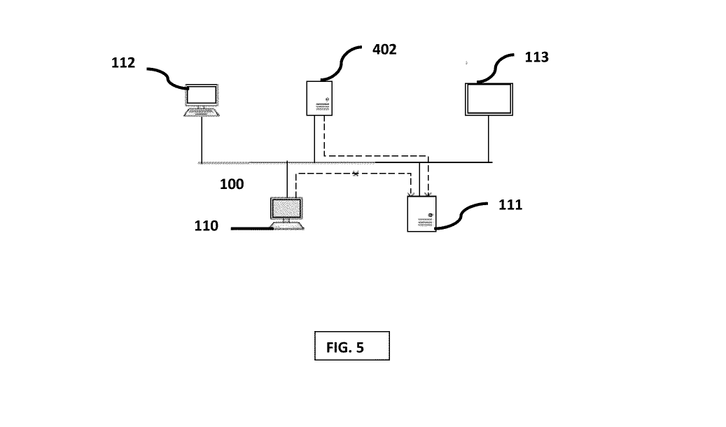

Referring to FIG. 5, illustrates the capability of the AND system or device 305 to provide limited access or authorized access to the network resource by implementing a scalable access control service. In an embodiment, the authorized or unauthorized access to the network resource is implemented by using an access control list (ACL) in a filtering device. The filtering device processes the IP packets and responds to the network request immediately.

When a disallowed traffic is destined to a host or when a hostile host sends a request to a destined host, the filtering device intercepts the request and responds on behalf of the destined host.

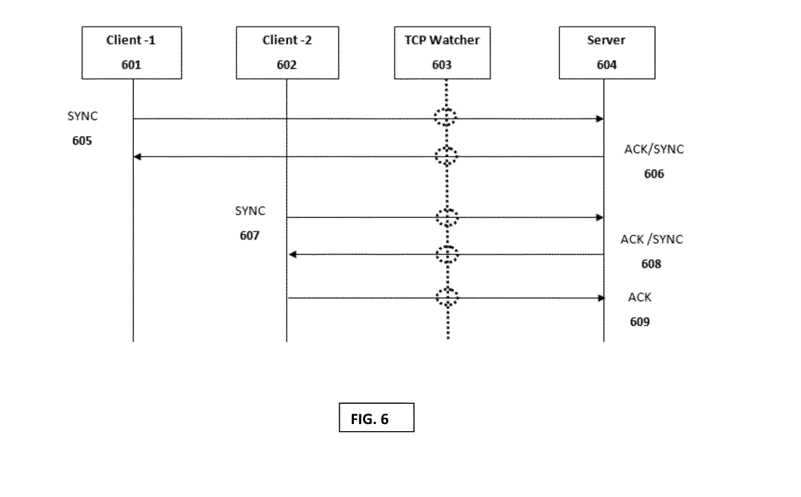

Referring to FIG. 6, illustrates the procedure followed for setting up a TCP connection and monitoring the TCP connection using a TCP watcher device. As depicted in the figure, Client-1 and Client-2 sends a TCP connection request (SYN) to the Server. The Server upon receiving the TCP connection request (SYN) from the clients, the Server sends the acknowledgement response to the Client-1 and Client-2. The Server sends ACK/SYN response to the requesting clients. Further, a connection is established between Client-2 and the server as the client responds with a SYN response to the Server. In an embodiment, the TCP watcher device monitors the TCP connection established between one or more clients and the server within the network.

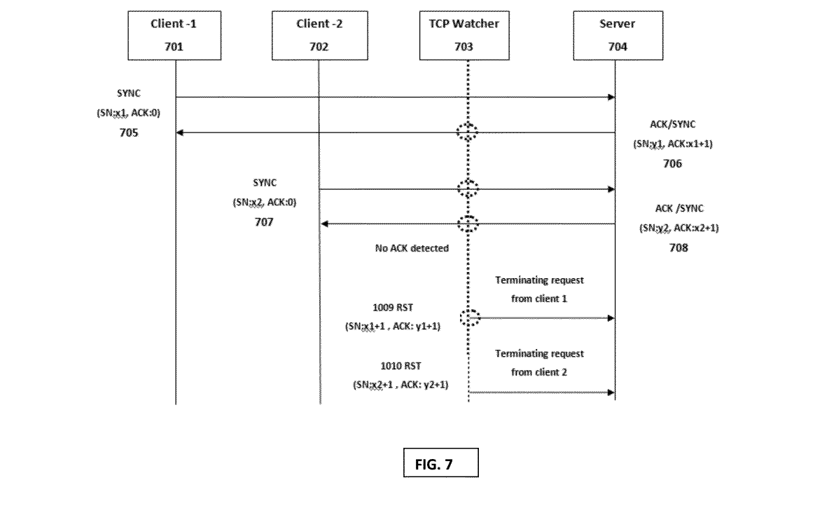

Referring to FIG. 7, illustrates the capability of the AND system or device to terminate one or more unwanted connections established with the server to protect the network infrastructure. In an embodiment, as an attacker sends a large number of SYN packets to a victim server without follow-up ACK message at the end, the server receives a SYN packet and allocates resources to get ready for a TCP connection. A large number of the connection requests may exhaust the resources on the server and the server may not be able to service other requests. In an embodiment, the resource cleanup is performed through a TCP watcher device that monitors the host traffic. The TCP watcher device sends the Reset (RST) packets, on behalf of the client, to the server to help the server terminate the outstanding resources allocated for the half-connected TCP connection. The TCP watcher device sends the RST packets to the server based on some rules and heuristics using time, number of packets, packet rate, source and destination hosts or on demands by the network operator.

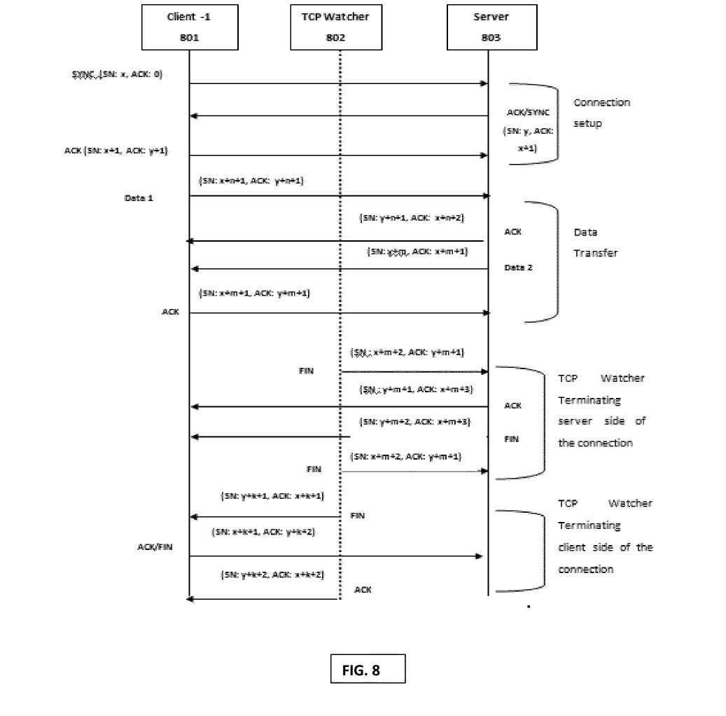

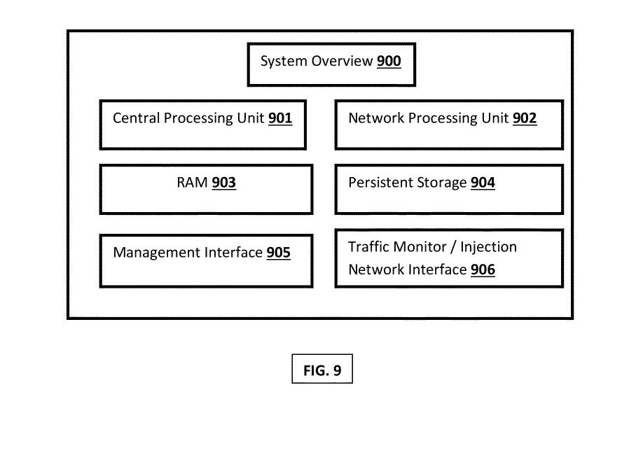

Referring to FIG. 8, illustrates the capability of the AND system or device to terminate one or more unwanted connections established between one or more clients and servers to protect the network infrastructure. As depicted in the figure, initially, the client establishes a connection with the server by sending SYN/ACK (synchronization and acknowledgement) 3-way handshake signal. After establishing the connection, data is exchanged between the client and the server. In an embodiment, the TCP watcher device constantly monitors the connection established between the client and the server and the data transfer occurring between the client and the server. As the data transfer from the client to the server is transacted, the TCP watcher device constantly monitors the traffic between the client and the server. Based on the instruction received from the network operator or the network configuration details, the TCP watcher device may choose to terminate a connection by sending a close function (FIN) status signal to the server. Upon receiving the FIN signal from the TCP watcher device, the server sends ACK/FIN response to the client (as part of standard TCP connection termination) and the TCP watcher device finishes terminating the server side connection. Further, the TCP watcher device sends a FIN signal to the client. Upon receiving the FIN signal from the TCP watcher device, the client may send the ACK/FIN signal to the server and as the server receives the ACK/FIN signal, the TCP watcher device sends an ACK response to the client for terminating the client side connection.

Referring to FIG. 9, illustrates the system overview 900 of the components required to implement the features for protecting the network infrastructure. In an embodiment, the network infrastructure can be protected by using the following components: a Central Processing Unit (CPU) 901, a Network Processing unit 902, a RAM 903, a Persistent Storage 904, a Management Interface 905, and a Traffic monitor/Injection network interface 906. A CPU 901 is used to process the instructions stored in a Random Access Memory (RAM) 903. The Network Processing unit 902 is used for processing the network related functions. The Persistent Storage 904 is used for storing the configuration information of the network assets, logging and general purpose storage. The management interface 905 is used for managing and administering network interface within the network infrastructure. In an embodiment, the Traffic monitor/Injection network interface 906 is used for monitoring the network traffic and the network resources within the network infrastructure. The functionalities of the components may be combined into one or multiple physical assets. For example, the management interface may be combined with the traffic monitor/injection interface. The Central Processing Unit (CPU) may be combined with the Network Processing Unit (NPU) to save the device cost. The management interface may be an Ethernet internet or a computer bus interface like USB port, PCI, PCIe, RS232, RS485, thunderbolt, fire wire, and so on.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

What is claimed is:

1. A method, executed by at least one processor, to actively defend a network infrastructure with reduced performance cost and network complexity, wherein said method comprises of:
protecting said network infrastructure from hostile scanning;
providing a faster authenticated and limited access response to a network traffic request;
protecting a network connection by intervening a Transmission Control Protocol (TCP) connection that is established between at least one client and at least one server within said network infrastructure; and
cleaning up synchronize packet (SYN) flood attacks to terminate at least one outstanding TCP connection.

2. The method as claimed in claim 1, wherein said network infrastructure is protected from hostile scanning by making the process of network scanning ineffective.

3. The method as claimed in claim 2, wherein the process of network scanning is made ineffective by converting at least one asset of said network infrastructure into a fictitious asset.

4. The method as claimed in claim 3, wherein said at least one asset of said network infrastructure includes but not limited to a server, a client, a router, a network channel, a filtering device.

5. The method as claimed in claim 1, provides a faster authenticated and limited access response to said network traffic request by implementing a scalable access control list in a filtering device by authenticating and filtering said network traffic destined to a specific host.

6. The method as claimed in claim 5, wherein said scalable access control list implemented in said filtering device can be authorized independent of a gateway connection.

7. The method as claimed in claim 5, wherein said filtering device can be at least one device available within said network infrastructure and said filtering device intercepts said network traffic request that is determined to be illegitimate to be transmitted to said at least one destined host within said network infrastructure.

8. The method as claimed in claim 1, wherein said TCP connection that is established between said at least one client and said at least one server within said network infrastructure can be intervened and disconnected by injecting proper network packets with specific sequence number in both said at least one client and said at least one server that is connected with said TCP connection.

9. The method as claimed in claim 8, wherein said specific sequence number can be injected by using at least one device available within the said network infrastructure, and wherein said at least one device is a TCP watcher.

10. The method as claimed in claim 1, wherein cleaning up SYN flood attacks to terminate at least one outstanding TCP connection by using at least one device, to send Reset (RST) packets to said at least one server to terminate any outstanding resources while establishing said at least one outstanding TCP connection, and wherein said at least one device is a TCP watcher.

11. The method as claimed in claim 10, wherein said at least one device sends RST packets based on rules and heuristics as defined by a network operator.

12. An active defender network device to secure network infrastructure with reduced performance cost and network complexity, wherein said device is configured to:
protect said network infrastructure from hostile scanning;
provide a faster authenticated and limited access response to a network traffic request;
protect a network connection by intervening a TCP connection that is established between at least one client and at least one server within said network infrastructure; and
clean up SYN flood attacks to terminate at least one outstanding TCP connection.

13. A system that actively defends a network infrastructure with reduced performance cost and network complexity, wherein the system comprises of an active network defender device module, a filtering device module, and a watcher device module and the system is configured to:
protect said network infrastructure from hostile scanning by using said active network defender device module;
provide a faster authenticated and limited access response to a network traffic request by using said active network defender device module;
protect a network connection by intervening a TCP connection that is established between at least one client and at least one server within said network infrastructure by using said filtering device module; and
cleaning up SYN flood attacks to terminate at least one outstanding TCP connection by using said watcher device module.

14. The system as claimed in claim 13, wherein said network infrastructure is protected from hostile scanning by making the network scanning ineffective.

15. The system as claimed in claim 14, wherein the network scanning is made ineffective by converting at least one asset of said network infrastructure into a fictitious asset.

16. The system as claimed in claim 15, wherein said at least one asset of said network infrastructure includes but not limited to a server, a client, a router, a network channel.

17. The system as claimed in claim 13, provides a faster authenticated and limited access response to said network traffic request by implementing a scalable access control list in a filtering device that is configured to authenticate and filter said network traffic destined to a specific host.

18. The system as claimed in claim 17, wherein said scalable access control list implemented in said filtering device can be authorized independent of a gateway connection.

19. The system as claimed in claim 17, wherein said filtering device can be at least one device available within said network infrastructure and said filtering device is configured to intercept said network traffic request that is determined to be illegitimate to be transmitted to said at least one destined host within said network infrastructure.

20. The system as claimed in claim 13, wherein said TCP connection that is established between said at least one client and said at least one server within said network infrastructure can be intervened and disconnected by injecting proper network packets with specific sequence number in both said at least one client and said at least one server that is connected with said TCP connection.

21. The system as claimed in claim 19, wherein said specific sequence number can be injected by using at least one device available within said network infrastructure, wherein at least one device is a TCP watcher.

22. The system as claimed in claim 13, wherein cleaning up SYN flood attacks to terminate at least one outstanding TCP connection by using at least one device, to send RST packets to said at least one server to terminate any outstanding resources while establishing said at least one outstanding TCP connection with said at least one client in said network infrastructure, and wherein at least one device is a TCP watcher.
